(19) United States
(12) Patent Application Publication
(10) Pub. No.: US 2025/0234060 A1
(43) Pub. Date: Jul. 17, 2025

(54) MULTI-USER MULTIMEDIA CONTROL METHOD, APPARATUS AND SYSTEM, AND DEVICE AND MEDIUM

(71) Applicant: Beijing Zitiao Network Technology Co., Ltd., Beijing (CN)

(72) Inventors: Jiesheng CHEN, Beijing (CN); Haiyun CHEN, Beijing (CN)

(21) Appl. No.: 18/849,406

(22) PCT Filed: Mar. 17, 2023
(86) PCT No.: PCT/CN2023/082031

§ 371 Date: Sep. 20, 2024

(30) Foreign Application Priority Data
Mar. 31, 2022 (CN) 202210346489.2

(51) Int. Cl. H04N 21/43; H04N 21/2387

(52) U.S. Cl. CPC H04N 21/43076; H04N 21/2387

(57) ABSTRACT

The present disclosure relates to a multi-user multimedia control method, a device and a medium. The method is applied to a first client, and comprises: acquiring a time alignment request, which is sent by a second client in response to a multimedia sharing joining operation, and sending time information to the second client, such that the second client aligns the time thereof with that of a first client based on the time information, wherein there is at least one second client; in response to at least two control instructions carrying instruction times being received within a preset time, determining a target control instruction based on each instruction time; and executing a corresponding control operation on a target multimedia corresponding to the target control instruction, and sending the target control instruction to the second client, such that the second client synchronously executes the same control operation on the target multimedia.

### CROSS-REFERENCE TO RELATED APPLICATIONS

This application is a national phase application of international application No. PCT/CN2023/082031, filed on Mar. 17, 2023, which claims priority of Chinese patent application No. 202210346489.2, filed on Mar. 31, 2022, the disclosures of both applications are hereby incorporated herein in their entireties.

### TECHNICAL FIELD

The present disclosure relates to the technical field of multimedia control, and in particular, to a multi-user multimedia control method, apparatus, system, device and medium.

### BACKGROUND

With continuous development of Internet technology and multimedia technology, a plurality of users may watch multimedia synchronously in real time, which greatly improves multimedia watching experience and interactive experience.

### SUMMARY

The present disclosure provides a multi-user multimedia control method, apparatus, system, device and medium.

In a first aspect, an embodiment of the present disclosure provides a multi-user multimedia control method, the method being applied to a first client and comprising:
acquiring a time alignment request, which is sent by a second client in response to a multimedia sharing joining operation, and sending time information to the second client, such that the second client aligns the time thereof with that of the first client based on the time information, wherein there is at least one second client, and the multimedia sharing is an interactive function among a plurality of clients;
in response to receiving at least two control instructions carrying instruction times within a preset time, determining a target control instruction based on each instruction time;
performing a corresponding control operation on a target multimedia corresponding to the target control instruction, and sending the target control instruction to the second client, such that the second client synchronously performs the same control operation on the target multimedia.

In a second aspect, an embodiment of the present disclosure further provides a multi-user multimedia control method, the method being applied to a second client, and comprising:
sending a time alignment request to a first client in response to a multimedia sharing joining operation, and acquiring time information returned by the first client;
aligning the time of the second client with that of the first client based on the time information;
in response to a control triggering operation, sending a control instruction carrying instruction time to the first client, such that the first client, in response to receiving at least two control instructions carrying instruction times within a preset time, determines a target control instruction based on each instruction time, and performs a corresponding control operation on a target multimedia corresponding to the target control instruction;
receiving the target control instruction, and performing the same control operation as the first client on the target multimedia.

In a third aspect, an embodiment of the present disclosure further provides a multi-user multimedia control method, the method being applied to a system including a first client and at least one second client, and comprising:
sending, by the second client, a time alignment request to the first client in response to a multimedia sharing joining operation;
acquiring, by the first client, the time alignment request and sending time information to the second client;
aligning, by the second client, the time of the second client with that of the first client based on the time information, and sending a control instruction carrying instruction time to the first client in response to a control trigger operation;
determining, by the first client in response to receiving at least two control instructions carrying instruction times within a preset time, a target control instruction based on each instruction time, and performing a corresponding control operation on a target multimedia corresponding to the target control instruction, sending the target control instruction to the second client; and
receiving, by the second client, the target control instruction and performing the same control operation as the first client on the target multimedia.

In a fourth aspect, an embodiment of the present disclosure further provides a multi-user multimedia control apparatus, the apparatus being provided on a first client and comprising:
a first alignment module, configured to acquire a time alignment request, which is sent by a second client in response to a multimedia sharing joining operation, and send time information to the second client, such that the second client aligns the time thereof with that of the first client based on the time information, wherein there is at least one second client, and the multimedia sharing is an interactive function among a plurality of clients;
a first instruction module, configured to determine a target control instruction based on each instruction time in response to receiving at least two control instructions carrying instruction times within a preset time;
a first control module, configured to perform a corresponding control operation on a target multimedia corresponding to the target control instruction, and send the target control instruction to the second client, such that the second client synchronously performs the same control operation on the target multimedia.

In a fifth aspect, an embodiment of the present disclosure further provides a multi-user multimedia control apparatus, the apparatus being provided on a second client and comprising:
an information module, configured to send a time alignment request to a first client in response to a multimedia sharing joining operation, and acquire time information returned by the first client;
a second alignment module, configured to align the time of the second client with that of the first client based on the time information;
a second instruction module, configured to send a control instruction carrying instruction time to the first client in response to a control triggering operation, such that the first client, in response to receiving at least two control instructions carrying instruction times within a preset time, determines a target control instruction based on each instruction time, and performs a corresponding control operation on a target multimedia corresponding to the target control instruction; and
a second control module, configured to receive the target control instruction and perform the same control operation as the first client on the target multimedia.

In a sixth aspect, an embodiment of the present disclosure further provides a multi-user multimedia control system, including a first client and at least one second client. The first client is configured to execute the multi-user multimedia control method described in the first aspect, and the second client is configured to execute the multi-user multimedia control method described in the second aspect.

In a seventh aspect, an embodiment of the present disclosure further provides an electronic device, the electronic device comprising: a processor; a memory for storing instructions executable by the processor; the processor being configured to read the executable instructions from the memory and execute the instructions to implement the multi-user multimedia control method provided by the embodiment of the present disclosure.

In an eighth aspect, an embodiment of the present disclosure further provides a computer-readable storage medium having a computer program stored thereon, which is configured to execute the multi-user multimedia control method provided by the embodiments of the disclosure.

In a ninth aspect, an embodiment of the present disclosure further provides a computer program, comprising:
computer-readable instructions, which, when executed by a processor, cause the processor to implement the multi-user multimedia control method provided by the embodiments of the present disclosure.

In a tenth aspect, an embodiment of the present disclosure further provides a computer program product including computer readable instructions, which, when executed by a processor, cause the processor to implement the multi-user multimedia control method provided by the embodiments of the present disclosure.

### BRIEF DESCRIPTION OF THE DRAWINGS

The above and other features, advantages, and aspects of various embodiments of the present disclosure will become more apparent with reference to the following detailed description taken in conjunction with the accompanying drawings. Throughout the drawings, the like or similar reference numbers indicate the like or similar elements. It is to be understood that the drawings are schematic and that originals and elements are not necessarily drawn to scale.

FIG. 1 is a schematic flowchart of a multi-user multimedia control method provided by an embodiment of the present disclosure;

FIG. 2 is a schematic diagram of a multimedia control provided by an embodiment of the present disclosure;

FIG. 3 is a schematic flowchart of another multi-user multimedia control method provided by an embodiment of the present disclosure;

FIG. 4 is a schematic diagram of time alignment provided by an embodiment of the present disclosure;

FIG. 5 is a schematic flowchart of yet another multi-user multimedia control method provided by an embodiment of the present disclosure;

FIG. 6 is a schematic structural diagram of a multi-user multimedia control apparatus provided by an embodiment of the present disclosure;

FIG. 7 is a schematic structural diagram of another multi-user multimedia control apparatus provided by an embodiment of the present disclosure;

FIG. 8 is a schematic structural diagram of an electronic device provided by an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, which rather are provided for a more thorough and complete understanding of the present disclosure. It should be understood that the drawings and embodiments of the present disclosure are for illustrative purposes only and are not intended to limit the protection scope of the present disclosure.

It should be understood that various steps recited in the method implementations of the present disclosure may be executed in different orders and/or executed in parallel. Furthermore, method implementations may include additional steps and/or omit performance of illustrated steps. The scope of the present disclosure is not limited in this respect.

As used herein, the term “include” and its variations are open-ended, i.e., “including but not limited to.” The term “based on” means “based at least in part on.” The term “one embodiment” means “at least one embodiment”; the term “another embodiment” means “at least one additional embodiment”; and the term “some embodiments” means “at least some embodiments”. Relevant definitions of other terms will be given in the description below.

It should be noted that concepts such as “first” and “second” etc. mentioned in the present disclosure are only used to distinguish different apparatus, modules or units, and are not used to limit the order of functions performed by these apparatus, modules or units or interdependence.

It should be noted that modifications of “one” and “a plurality of” mentioned in the present disclosure are illustrative and not restrictive. Those skilled in the art should understand that they should be construed as “one or more” unless context clearly indicates otherwise.

The names of messages or information interacted between a plurality of apparatus in the embodiments of the present disclosure are for illustrative purposes only and are not used to limit the scope of these messages or information.

At present, in response to multiple users watching a same multimedia synchronously in real time, each user is enabled to control the multimedia. However, in response to a conflict among control instructions from the multiple users, it may cause confusion in multimedia playback, obvious jumps, thereby affecting user experience.

Specifically, in a case where multiple users watch the same multimedia synchronously in real time, each user is enabled to control the multimedia, that is, any user among the multiple users watching the multimedia synchronously is allowed to perform various control operations on the multimedia at any time. In response to control instructions of control operations from each of the users not conflicting, they can be operated sequentially in a round-based manner. However, in response to control instructions from the multiple users conflicting, it may cause issues such as confusion in multimedia playback, obvious jumps, thereby affecting user experience. In order to solve above problems, an embodiment of the present disclosure provides a multi-user multimedia control method, which will be introduced below with reference to specific embodiments.

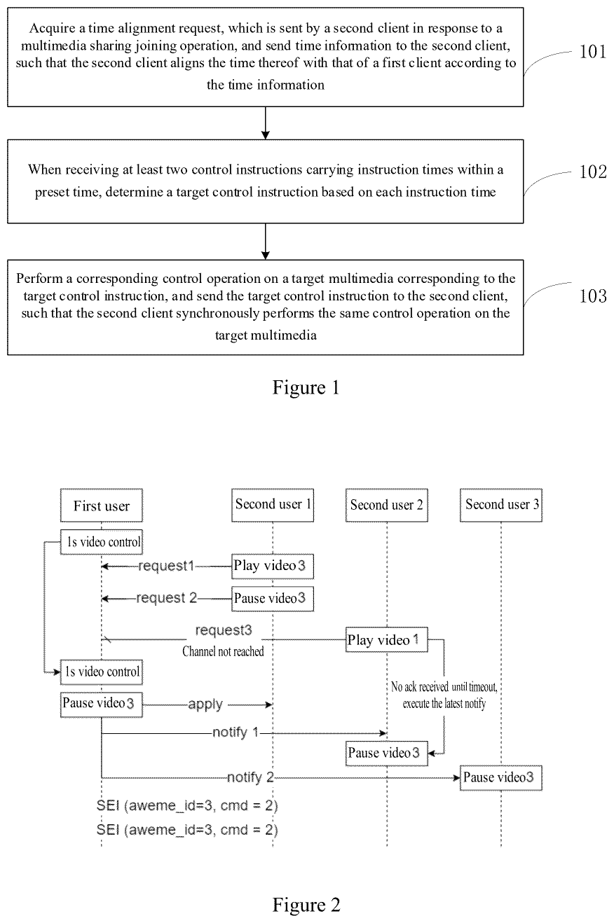

FIG. 1 is a schematic flowchart of a multi-user multimedia control method provided by an embodiment of the present disclosure. The method may be executed by a multi-user multimedia control apparatus. The apparatus may be implemented in software and/or hardware, and may generally be integrated into an electronic device. As shown in FIG. 1, the method is applied to a first client, comprising:

Step 101: acquiring a time alignment request, which is sent by a second client in response to a multimedia sharing joining operation, and sending time information to the second client, such that the second client aligns the time thereof with that of a first client based on the time information.

The multimedia sharing may be an interactive function among a plurality of clients. The first client may be a control end in a multi-user multimedia control scenario, and a corresponding first user may be understood as an initiating user of a multimedia watched by multiple users synchronously, and may actively send out a watching invitation. The second client may be a joining end in the multi-user multimedia control scenario, and a corresponding second user may actively join or be invited to join by the first user. There is at least one second client. The embodiment of the present disclosure may realize multi-user synchronously watching a multimedia through a multimedia room or live, which is determined based on the actual situation.

The multimedia sharing joining operation may be understood as an operation performed by the second user in the second client in response to a multimedia sharing invitation request sent by the first client to indicate acceptance of the invitation, or an operation of actively joining based on a notification that the first user is in a multimedia sharing state, which may specifically include a gesture control operation or a voice control operation, etc. The time alignment request may be a request sent by the second client for time alignment with the first client. The time information may be the current time when the time alignment request is received, as sent by the first client. Time alignment, also known as clock alignment, may be understood as setting the time of two clients on the same timeline, that is, indicating time synchronization. In the embodiment of the present disclosure, each second client needs to perform time alignment with the first client.

Specifically, after detecting a multimedia sharing joining operation from the second user, the second client may send a time alignment request to the first client. After receiving the time alignment request, the first client may send time information of the current time to the second client; the second client determines a delay between the second client and the first client based on the time information and a preset delay formula, and adjusts the time thereof to be aligned with the time of the first client according to the delay between the second client and the first client.

Step 102: in response to receiving at least two control instructions carrying instruction times within a preset time, determining a target control instruction based on each instruction time.

The preset time may be a time period for the first client to determine the target control instruction, that is, the first client performs an operation of deciding the target multimedia control instruction once every preset time. The specific time of the preset time may be set according to actual situations, for example, the preset time may be set to 1 second. The instruction time may be a sending time of the control instruction, and the control instruction may be understood as an instruction used to perform control operation on a multimedia. Instruction times, targeted multimedia, and specific control operations of different control instructions may be different. The target control instruction may be a final control instruction determined by the first client as a control end.

In response to the time of the second client being aligned with that of the first client, instruction times of the at least two control instructions are located on the same timeline, that is, after the time alignment in step 101, time synchronization is achieved between the first client and the second client.

In an embodiment of the present disclosure, in response to a first client receiving at least two control instructions within a preset time, the at least two control instructions may come from the first client and/or a second client, and at this time, it is determined that an instruction conflict scenario occurs, and a target control instruction may be determined according to the instruction time of each control instruction. Optionally, determining the target control instruction according to each instruction time may include: comparing the instruction times of the at least two control instructions, and determining a control instruction with the latest instruction time as the target control instruction according to the comparison result.

In response to the first client determining the target control instruction based on each instruction time, it may compare the instruction times to obtain the comparison result, and determine the control instruction with the latest time among the instruction times as a final target control instruction. For example, assuming that the first client receives three control instructions, the time of the first control instruction is 10:05:01, the time of the second control instruction is 10:05:02, and the time of the third control instruction is 10:05:03, then the third control instruction is a target control instruction.

Step 103: performing a corresponding control operation on a target multimedia corresponding to the target control instruction, and sending the target control instruction to the second client, such that the second client synchronously performs the same control operation on the target multimedia.

The control operation may include at least one of a play operation, a pause operation, a progress control operation, and an interactive operation. The multimedia includes a video, a media file composed of images and/or texts and supporting playback, etc., and the interactive operation may include a like operation, a comment operation, etc. The target multimedia may be the multimedia targeted by the target control instruction.

Specifically, after determining the target control instruction, the first client may perform a control operation on the target multimedia corresponding to the target control instruction, and may send the target control instruction to each second client, such that the first client and the second client synchronously perform the same control operation on the same target multimedia. For example, in response to the target control instruction being a pause operation for the current video, the first client and the second client synchronously implement the pause operation for the current video. It may be understood that, if one second client receives a pause operation for a video before playing the video, the video rendering may be displayed as remaining in a paused state at this time.

In some embodiments, after determining a target control instruction based on each instruction time, the multi-user multimedia control method may further comprise: in response to a sending end of the target control instruction being the first client, sending a rejection instruction to the second client among clients corresponding to the at least two control instructions.

After the first client determines the target control instruction, in response to determining that the sending end of the target control instruction is itself, it is indicated that the first user is in a busy state. At this time, it may reject the request from the second user, that is, send a rejection instruction to the second client among the clients corresponding to the at least two control instructions, thereby enabling a user at the control end to block other users from controlling the multimedia while the user is controlling the multimedia.

In related art, in a case that multiple users watch a multimedia synchronously, in response to the multiple users sliding frequently at the same time, there will be obvious jumps; and in response to the client of an inviting user being a control end, for a control instructions from other user, if it is not synchronized to the control end, it would be a failed instruction, which will cause the user to trust a wrong instruction, and then a situation that the instruction and the screen are inconsistent will occur.

In this solution, with time alignment, it may ensure that, in a scenario where multiple users watch a multimedia synchronously, all users are on the same timeline. Therefore, in response to a controlling client making an instruction decision, it is guaranteed that the last instructions of all users are consistent, regardless of sequentiality, correctness, or the like of intermediate processes, thereby ensuring the consistency of results of multimedia control; and by using a client, e.g. the client of the inviting user, as the control end for making instruction decision and control, the problem of inconsistency between instructions and screens due to failure to send instructions is improved, thereby improving the experience of synchronous multimedia watching.

In the multi-user multimedia control solution provided by the embodiment of the present disclosure, the first client may acquire a time alignment request, which is sent by a second client in response to a multimedia sharing joining operation, and send time information to the second client, such that the second client aligns the time thereof with that of a first client based on the time information, wherein there is at least one second client, and the multimedia sharing is an interactive function among a plurality of clients; in response to receiving at least two control instructions carrying instruction times within a preset time, determine a target control instruction based on each instruction time; and perform a corresponding control operation on a target multimedia corresponding to the target control instruction, and send the target control instruction to the second client, such that the second client synchronously performs the same control operation on the target multimedia. Using the above technical solution, in response to multiple users watching a multimedia synchronously, a client of one user may serve as a control end, and send time information after a client of another user joins to align the time thereof with that of the control end, and then in response to the control end receiving a plurality of control instructions, it may make decisions based on the instruction times, determine the final responsive control instruction and control the multimedia, which solves the problem of multimedia control confusions when there is a conflict among control instructions, and may realize instruction decision-making when there is a conflict among instructions, to enable multiple users watching a multimedia synchronously to achieve synchronous control of the multimedia, which improves obvious jumps and thereby improving the experience of synchronously watching multimedia.

Next, the multi-user multimedia control method of the embodiment of the present disclosure will be further explained through a specific example. Illustratively, FIG. 2 is a schematic diagram of a multimedia control provided by an embodiment of the present disclosure. As shown in FIG. 2, the multimedia in the figure takes video as an example, showing a video control process in a situation that a first user is watching a video with three second users synchronously. Since there is a certain success rate in sending and receiving instructions and the playback of a video is decided by the first user, the first client may be used as a control end to decide the final succussed instruction; the specific video control process may include: a second user 1 plays video 3 and sends instruction 1 (that is, “request 1” in the figure) to the first user, in the request 1, clock=1, cmd=1, and aweme_id=3, wherein clock represents instruction time, cmd represents a control operation corresponding to the instruction, 1 represents the playback operation, and aweme_id represents a video targeted by the instruction, and a 3 s timeout for waiting is started, and the instruction of the request is sent successfully; a second user 1 pauses video 3 and sends instruction 2 (that is, “request 2” in the figure) to the first user, in the request 2, clock=2, cmd=2, which represents a pause operation, aweme_id=3, and a 3 s timeout waiting is started, and the instruction of the request is sent successfully; the second user 2 plays video 1 and sends instruction 3 (that is, “request 3” in the figure) to the first user, in the request 3, clock=3, cmd=1, aweme_id=1, and a 3 s timeout waiting is started, and the instruction of the request fails to be sent.

After the first user receives the instruction, if it is currently in a busy state (that is, the first user is also currently performing a control triggering operation), it will reject the request from the second user and reply with a rejection instruction (“reject”); otherwise, it will check numerical values of clocks. If it receives an instruction with a clock having a value smaller than currently promised clock, then the instruction will be discarded directly; if it receives an instruction with a clock having a value larger than the currently promised clock, it will approve the instruction with current clock and promise not to receive instructions having a clock with a value smaller than this clock. The first user may reply to the second user 1 to approve the instruction (that is, “apply” in the figure), and in the approval instruction, clock=2, and the instruction time is the latest; and distribute the instruction to the second user 2 and the second user 3 to notify the instruction (that is, “notify” in the figure). In the notification instruction, clock=2, cmd=2, aweme=3, and starts to push an information (Supplemental Enhancement information, SEI) flow of pause aweme_id=3. Each time the first user completes a decision on an instruction, the first user needs to wait for 1 s for video control before processing the next instruction.

After the second user 1 receives an approval instruction, it promises not to receive a notification with a clock having a value smaller than this clock and waits for the corresponding SEI stream to arrive; the second user 2 waits until timeout for the approval instruction and then executes the latest notification instruction; and after the second user 2 and the third user 2 receive a notification instruction with clock=2 from the first user, if they receive a notification instruction with a clock value smaller than currently promised clock, they will discard it directly; otherwise, they will choose the notification instruction of the current clock and promise not to receive a notification instruction with a clock value smaller than the clock.

As shown in FIG. 2, both the second user 1 and the second user 2 sent video control instructions to the first user within 1 second. The first user only receives two video control instructions sent by the second user 1 and determines the video control instruction of pausing video 3 with the latest instruction time as a target video control instruction, and distributes the target video control instruction of pausing video 3 to the second user 1, the second user 2 and the second user 3, such that the first user and the second user 1, the second user 2 and the second user 3 all perform a pause operation on the video 3.

In this solution, if the first user is called a host and the second user is called a guest, both the host and the guest can control the video. In response to the host being in an idle state, it can receive a request sent by the guest and give an approval reply. The idle state characterizes that itself is not operating the video; in response to the host touching the screen, it can receive a request sent by the guest and give a rejection reply; in response to the host lifting hand, if it is a valid instruction, it will send a notification signaling, otherwise it will take a currently promised instruction to execute; the guest, in response to being in the idle state, can receive the notification signaling sent by the host and process it; in response to the guest touching the screen, it can receive a notification signaling sent by other guests or the host, and promise to use the last instruction, but does not do any processing; in response to the guest lifting hand, if it is a valid instruction, it will send a request, otherwise it will take a currently promised instruction to execute. That is, in response to the host controlling the video, operations of all other guests on the video are blocked; in response to the guest controlling the video, operations of other guests and the host are not blocked, but its own player is still displaying the currently controlled video.

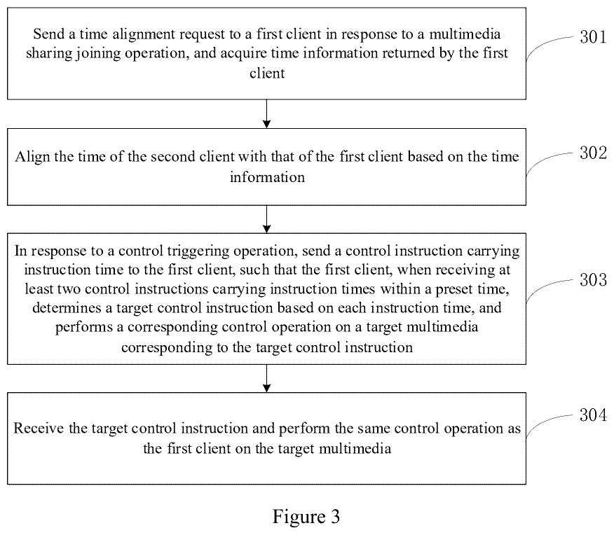

FIG. 3 is a schematic flowchart of another multi-user multimedia control method provided by an embodiment of the present disclosure. This method may be executed by a multi-user multimedia control apparatus, wherein the apparatus may be implemented in software and/or hardware, and may generally be integrated into an electronic device. As shown in FIG. 3, the method is applied to a second client, comprising:

Step 301: sending a time alignment request to a first client in response to a multimedia sharing joining operation, and acquiring time information returned by the first client.

The second client may be a joining end in a multi-user multimedia control scenario, and corresponding second user may actively join or may be invited to join by the first user. There is at least one second client. The multimedia sharing joining operation may be understood as an operation performed by the second user in the second client in response to a multimedia sharing invitation request sent by the first client to indicate acceptance of the invitation, or an operation of actively joining based on a notification that the first user is in a multimedia sharing state, which may specifically include a gesture control operation or a voice control operation, etc. The time alignment request may be a request sent by the second client for time alignment with the first client. The time information may be the time when the time alignment request is received, as sent by the first client.

Specifically, after the second client receives the multimedia sharing invitation request, it may be displayed to the second user. If the second user wants to accept the invitation, it may trigger an multimedia sharing joining operation, or after seeing a notification that the first user is in a multimedia sharing state, the second user may trigger the multimedia sharing joining operation actively; after detecting the multimedia sharing joining operation from the second user, the second client may send a time alignment request to the first client, and after receiving the time alignment request, the first client may send time information of current time to the second client, which may receive the time information.

Step 302: aligning the time of the second client with that of the first client based on the time information.

The above time alignment request includes a first time when the request is sent, and the time information includes a second time when the first client receives the time alignment request. Time alignment, also known as clock alignment, may be understood as setting the time of two clients on the same timeline, that is, characterizing time synchronization. In the embodiment of the present disclosure, each second client needs to perform time alignment with the first client, and time alignment also needs to be re-aligned in response to the first user changing.

In the embodiment of the present disclosure, aligning the time of the second client with that of the first client based on the time information may include: determining a delay between the second client and the first client according to the first time, the second time, a third time when receiving the time information, and a delay formula; and adding the delay to the real time of the second client to achieve time alignment with the first client.

The delay may be understood as the time difference between the two clients. The delay formula may be expressed as delay=((t2−t1)+(t2−t3))/2=t2−(t1+t3)/2, wherein delay represents the delay between the second client and the first client, t1 represents the above first time, t2 represents the above second time, and t3 represents the above third time. After determining the delay between itself and the first client, the second client may add the delay to its own real time to achieve time synchronization with the first client.

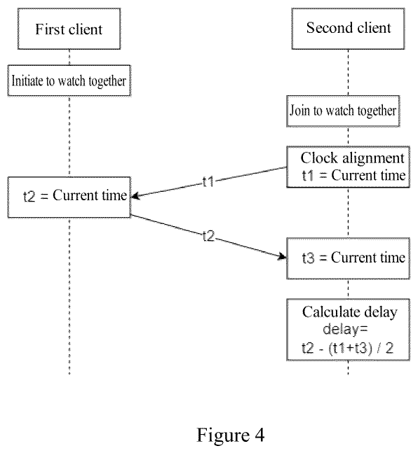

Exemplarily, FIG. 4 is a schematic diagram of time alignment provided by an embodiment of the present disclosure. As shown in FIG. 4, it shows a time alignment process between a second client and a first client. The specific process may include: the first client may initiate an invitation to the second client to watch together; in response to the second client joining to watch together, it will actively perform time alignment with the first client; the second client acquires a current time t1 and sends it to the first client; the first client sends a current time t2 in response to it receiving t1 to the second client; after receiving t2 sent by the first client, the second client may acquire a current time t3 and input t1, t2 and t3 into the delay formula to obtain the delay between the second client and the first client, and adjust the real time of the second client from curTime to curTime+delay.

Optionally, the step of aligning the time of the second client with that of the first client is executed a preset number of times every set time. The set time may be understood as a time period for performing time alignment, and the preset number of times may be the number of time alignments per round. For example, the set time may be set to 2 minutes, and the preset number of times is 5 times. At this time, A round of time alignment is performed every two minutes, and time alignment is performed 5 times per round. By periodically executing the time alignment step a plurality of times, the accuracy of time delay determination can be improved, the accuracy of time alignment can be improved, and the accuracy of subsequent multimedia control can be further improved.

It may be understood that the delay above is mainly affected by factors such as channels and networks, but the impact is small, and this impact may be ignored in the embodiments of the present disclosure.

Optionally, multi-user multimedia control may also comprise: displaying an alignment failure notification in response to the delay being greater than or equal to a delay threshold, wherein the delay threshold may be set in advance, for example, the delay threshold may be set to 300 milliseconds. After determining a delay between the second client and the first client, the second client may compare the delay with the delay threshold and determine whether the delay is greater than or equal to the delay threshold. If not, the time alignment may be performed; if so, it means that time alignment cannot be performed, and an alignment failure notification may be displayed to the second user, such that the second user knows that time alignment cannot be performed and needs manual troubleshooting.

Step 303: in response to a control triggering operation, sending a control instruction carrying instruction time to the first client, such that the first client, in response to receiving at least two control instructions carrying instruction times within a preset time, determines a target control instruction based on each instruction time, and performs a corresponding control operation on a target multimedia corresponding to the target control instruction.

The instruction time may be the time after the second client has been time aligned. Wherein the control triggering operation of the second user may be a triggering operation performed by the second user on a multimedia in a scenario where multiple users watch the multimedia synchronously. Specifically, the control triggering operation may include a gesture control operation or a voice control operation, etc. For example, the control triggering operation of the second user may be an upward sliding operation on the current multimedia, and this operation may also represent a playback operation for the previous video of the current video.

In response to the control triggering operation of the second user, the second client may send a control instruction carrying instruction time to the first client; in response to receiving at least two control instructions within a preset time, the first client determines at this time that an instruction conflict scenario occurs, and determines a control instruction with the latest instruction time as a target control instruction according to the instruction time of each control instruction; the first client performs a control operation on the target multimedia corresponding to the target control instruction, and may send the target control instruction to each second client.

Step 304: receiving the target control instruction, and performing the same control operation as the first client on the target multimedia.

The second client may receive the target control instruction sent by the first client, and perform the same control operation as the first client on the target multimedia according to the target control instruction. For example, in response to the target control instruction being a pause operation for the current video, the first client and the second client synchronously implement the pause operation for the current video.

Optionally, after step 302, if the second user does not perform a playback control triggering operation, then the second client may not perform step 303 and directly perform step 304, which is determined according to the actual situation.

In the multi-user multimedia control solution provided by the embodiment of the present disclosure, the second client sends a time alignment request to a first client in response to a multimedia sharing joining operation, and acquires time information returned by the first client; align the time of the second client with that of the first client based on the time information; in response to a control triggering operation, sends a control instruction carrying instruction time to the first client, such that in response to receiving at least two control instructions carrying instruction times within a preset time, the first client determines a target control instruction based on each instruction time, and performs a corresponding control operation on a target multimedia corresponding to the target control instruction; receives the target control instruction, and performs the same control operation as the first client on the target multimedia. Using the above technical solution, in response to multiple users watching a multimedia synchronously, a client of one user may be time aligned with a control client after joining. After the time alignment and in response to receiving a plurality of control instructions, the control client may make decision according to instruction times, determines a final responsive control instruction and controls the multimedia, which solves the problem of multimedia control confusions when there is a conflict among control instructions, and may realize instruction decision-making when there is a conflict among instructions, to enable multiple users watching a multimedia synchronously to achieve synchronous control of the multimedia, which improves obvious jumps and thereby improving the experience of synchronously watching multimedia.

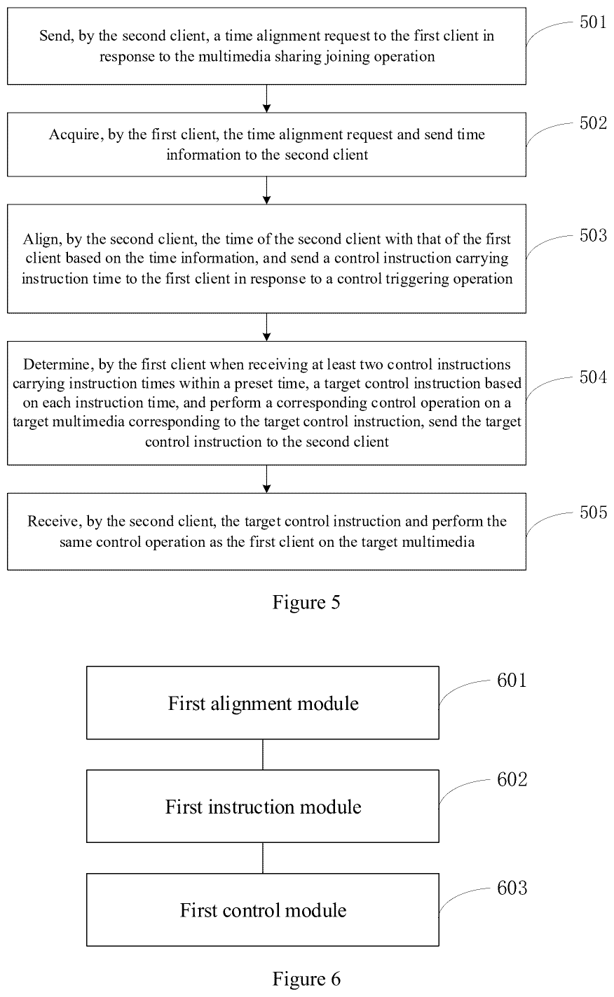

FIG. 5 is a schematic flowchart of yet another multi-user multimedia control method provided by an embodiment of the present disclosure. This method may be executed by a multi-user multimedia control apparatus, wherein the apparatus may be implemented in software and/or hardware, and may generally be integrated into an electronic device. As shown in FIG. 5, the method is applied to a system including a first client and at least one second client, comprising:

Step 501: sending, by the second client, a time alignment request to the first client in response to the multimedia sharing joining operation.

Step 502: acquiring, by the first client, the time alignment request and sending time information to the second client.

Step 503: aligning, by the second client, the time of the second client with that of the first client based on the time information, and sending a control instruction carrying instruction time to the first client in response to a control triggering operation.

Step 504: determining, by the first client in response to receiving at least two control instructions carrying instruction times within a preset time, a target control instruction based on each instruction time, and performing a corresponding control operation on a target multimedia corresponding to the target control instruction, sending the target control instruction to the second client.

Step 505: receiving, by the second client, the target control instruction and performing the same control operation as the first client on the target multimedia.

In the multi-user multimedia control solution provided by the embodiment of the present disclosure, in a case where multiple users watch multimedia synchronously, a client of one user may serve as a control end, and after a client of another user joins, it sends time information to make it perform time alignment with the control end, and after that, in response to the control end receiving a plurality of control instructions, it may make decision according to instruction times, determine a final responsive control instruction and control the multimedia, which solves the problem of multimedia control confusions when there is a conflict among control instructions, and may realize instruction decision-making when there is a conflict among instructions, to enable multiple users watching a multimedia synchronously to achieve synchronous control of the multimedia, which improves obvious jumps and thereby improving the experience of synchronously watching multimedia.

An embodiment of the present disclosure further provides a multi-user multimedia control system, comprising the above first client and at least one above second client. The first client is used to execute the above multi-user multimedia control method as shown in FIG. 1, and the second client is used to execute the multi-user multimedia control method as shown in FIG. 3.

FIG. 6 is a schematic structural diagram of a multi-user multimedia control apparatus provided by an embodiment of the present disclosure. The apparatus may be implemented in software and/or hardware, and may generally be integrated into an electronic device. As shown in FIG. 6, the apparatus is provided on a first client and comprises:
a first alignment module 601, configured to acquire a time alignment request, which is sent by a second client in response to a multimedia sharing joining operation, and send time information to the second client, such that the second client aligns the time thereof with that of a first client based on the time information, wherein there is at least one second client, and the multimedia sharing is an interactive function among a plurality of clients;
a first instruction module 602, configured to determine a target control instruction based on each instruction time in response to receiving at least two control instructions carrying instruction times within a preset time; and
a first control module 603, configured to perform a corresponding control operation on a target multimedia corresponding to the target control instruction, and send the target control instruction to the second client, such that the second client synchronously performs the same control operation on the target multimedia.

Optionally, the first instruction module 602 is configured to:
compare the instruction times of the at least two control instructions, and determine the control instruction with the latest instruction time as the target control instruction according to the comparison result.

Optionally, after the time of the second client is aligned with that of the first client, the instruction times of the at least two control instructions are located on the same timeline.

Optionally, the apparatus further comprises a rejection module, configured to: after determining a target control instruction based on each instruction time,
in response to a sending end of the target control instruction being the first client, send a rejection instruction to the second client among clients corresponding to the at least two control instructions.

Optionally, the preset time is a time period for the first client to determine the target control instruction.

Optionally, the control operation includes at least one of a play operation, a pause operation, a progress control operation and an interactive operation, and the multimedia includes a video, a media file composed of images and/or texts and supporting playback.

The multi-user multimedia control apparatus provided by the embodiment of the present disclosure may execute the multi-user multimedia control method provided by any embodiment of the present disclosure, and has functional modules and beneficial effects corresponding to the execution of the method.

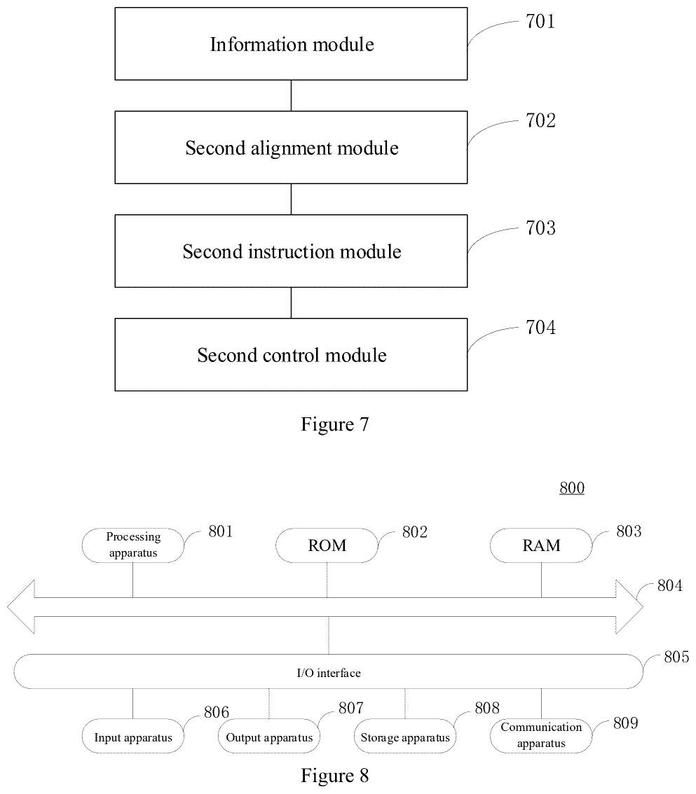

FIG. 7 is a schematic structural diagram of another multi-user multimedia control apparatus provided by an embodiment of the present disclosure. The apparatus may be implemented in software and/or hardware, and may generally be integrated into an electronic device. As shown in FIG. 7, the device is provided on a second client and comprises:
an information module 701, configured to send a time alignment request to a first client in response to a multimedia sharing joining operation, and acquire time information returned by the first client;
a second alignment module 702, configured to align the time of the second client with that of the first client based on the time information;
a second instruction module 703, configured to send a control instruction carrying instruction time to the first client in response to a control triggering operation, such that in response to receiving at least two control instructions carrying instruction times within a preset time, the first client determines a target control instruction based on each instruction time, and perform a corresponding control operation on a target multimedia corresponding to the target control instruction;
a second control module 704, configured to receive the target control instruction and perform the same control operation as the first client on the target multimedia.

Optionally, the time alignment request includes a first time when the request is sent, and the time information includes a second time when the first client receives the time alignment request;

The second alignment module 702 is configured to:
determine a delay between the second client and the first client according to the first time, the second time, a third time when the time information is received, and a delay formula;
add the delay to the real time of the second client to achieve time alignment with the first client.

Optionally, the apparatus further comprises an alignment failure module, configured to:
in response to the delay being greater than or equal to a delay threshold, display an alignment failure notification.

Optionally, the step of aligning the time of the second client with that of the first client is executed a preset number of times every set time.

The multi-user multimedia control apparatus provided by the embodiment of the present disclosure may execute the multi-user multimedia control method provided by any embodiment of the present disclosure, and has functional modules and beneficial effects corresponding to the execution of the method.

An embodiment of the present disclosure further provides a computer program product including a computer program/instruction, which, when executed by a processor, implement the multi-user multimedia control method provided by any of the disclosed embodiments.

FIG. 8 is a schematic structural diagram of an electronic device provided by an embodiment of the present disclosure. Referring specifically to FIG. 8 below, a schematic structural diagram suitable for implementing an electronic device 800 in an embodiment of the present disclosure is shown. The electronic device 800 in the embodiment of the present disclosure may include, but is not limited to, a mobile terminal such as a mobile phone, a notebook, a digital broadcast receiver, a PDA (Personal Digital Assistant), a PAD (tablet), a PMP (Portable Multimedia Player), a vehicle-mounted terminal (for example, a vehicle-mounted navigation terminal), etc. and a fixed terminal such as a digital TV, a desktop computer, etc. The electronic device shown in FIG. 8 is only one example, and should not bring any limitation to functions and usage scopes of the embodiments of the present disclosure.

As shown in FIG. 8, the electronic device 800 may include a processing device (e.g., a central processing unit, a graphics processor, etc.) 801, which may execute various appropriate actions and processes according to a program stored in a read-only memory (ROM) 802 or a program loaded from a storage 808 into a random-access memory (RAM) 803. In the RAM 803, various programs and data required for operations of the electronic device 800 are also stored. The processing apparatus 801, ROM 802 and RAM 803 are connected to each other via a bus 804. An input/output (I/O) interface 805 is also connected to bus 804.

Generally, the following apparatus may be connected to the I/O interface 805: an input apparatus 806 including, for example, a touch screen, a touch pad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. Although FIG. 8 illustrates an electronic device 800 having various apparatus, it should be understood that it is not required to implement or provide all of the illustrated apparatus. More or fewer apparatus may be implemented or provided alternatively.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program contains program code for executing the method illustrated in the flowchart. In such embodiments, the computer program may be downloaded and installed from the network via the communication apparatus 809, or installed from the storage apparatus 808, or installed from the ROM 802. When the computer program is executed by the processing apparatus 801, the above functions defined in the multi-user multimedia control method of the embodiment of the present disclosure are executed.

It should be noted that above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program, and the program may be used by or in combination with an instruction execution system, apparatus, or device. In the present disclosure, a computer-readable signal medium may include a data signal propagated in a baseband or as a part of a carrier wave, in which a computer-readable program code is carried. This propagated data signal may take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program for use by or in combination with the instruction execution system, apparatus, or device. The program code contained on the computer-readable medium may be transmitted by any suitable medium, including but not limited to: electrical wire, optical cable, RF (Radio Frequency), etc., or any suitable combination thereof.

In some embodiments, the client and server may communicate with any currently known or future developed network protocol such as HTTP (HyperText Transfer Protocol), and may interconnect with digital data communication (for example, communication network) in any form or medium. Examples of communication networks include local area networks (“LAN”), wide area networks (“WAN”), international network (for example, the Internet), and end-to-end networks (for example, ad hoc end-to-end networks), as well as any currently known or future developed networks.

The above computer-readable medium may be included in the above electronic device; or it may be stand-alone without being assembled into the electronic device.

The computer-readable medium carries one or more programs, which, when executed by the electronic device, cause the electronic device to: acquire a time alignment request, which is sent by a second client in response to a multimedia sharing joining operation, and send time information to the second client, such that the second client aligns the time thereof with that of a first client according to the time information, wherein there is at least one second client, and the multimedia sharing is an interactive function among a plurality of clients; in response to receiving at least two control instructions carrying instruction times within a preset time, determine a target control instruction based on each instruction time; perform a corresponding control operation on a target multimedia corresponding to the target control instruction, and send the target control instruction to the second client, such that the second client synchronously performs the same control operation on the target multimedia.

Alternatively, the above computer-readable medium carries one or more programs, which, when executed by the electronic device, cause the electronic device to: send a time alignment request to a first client in response to a multimedia sharing joining operation, and acquire time information returned by the first client; align the time of the second client with that of the first client based on the time information; in response to a control triggering operation, send a control instruction carrying instruction time to the first client, such that the first client, in response to receiving at least two control instructions carrying instruction times within a preset time, determines a target control instruction based on each instruction time, and performs a corresponding control operation on a target multimedia corresponding to the target control instruction; receive the target control instruction, and perform the same control operation as the first client on the target multimedia.

Alternatively, the computer-readable medium carries one or more programs, which, when executed by the electronic device, cause the electronic device to: send, by the second client, a time alignment request to the first client in response to a multimedia sharing joining operation; acquire, by the first client, the time alignment request and send time information to the second client; align, by the second client, the time of the second client with that of the first client based on the time information, and send a control instruction carrying instruction time to the first client in response to a control trigger operation; determine, by the first client in response to receiving at least two control instructions carrying instruction times within a preset time, a target control instruction based on each instruction time, and perform a corresponding control operation on a target multimedia corresponding to the target control instruction, send the target control instruction to the second client; receive, by the second client, the target control instruction and perform the same control operation as the first client on the target multimedia.

The technical solutions provided by the embodiments of the present disclosure have following advantages compared with related arts: in the multi-user multimedia control solution provided by the embodiments of the present disclosure, the first client may acquire a time alignment request, which is sent by a second client in response to a multimedia sharing joining operation, and send time information to the second client, such that the second client aligns the time thereof with that of a first client based on the time information, wherein there is at least one second client, and the multimedia sharing is an interactive function among a plurality of clients; in response to receiving at least two control instructions carrying instruction times within a preset time, determine a target control instruction based on each instruction time; perform a corresponding control operation on a target multimedia corresponding to the target control instruction, and send the target control instruction to the second client, such that the second client synchronously performs the same control operation on the target multimedia. Using the above technical solution, in response to multiple users watching a multimedia synchronously, a client of one user may serve as a control end, and send time information after a client of another user joins to align the time thereof with that of the control end, and then in response to the control end receiving a plurality of control instructions, it may make decisions based on the instruction times, determine the final responsive control instruction and control the multimedia, which solves the problem of multimedia control confusions when there is a conflict among control instructions, and may realize instruction decision-making when there is a conflict among instructions, to enable multiple users watching a multimedia synchronously to achieve synchronous control of the multimedia, which improves obvious jumps and thereby improving the experience of synchronously watching multimedia.

The computer program code for performing the operations of the present disclosure may be written in one or more programming languages or a combination thereof. The above programming languages include but are not limited to object-oriented programming languages such as Java, Smalltalk, C++, and include conventional procedural programming languages such as “C” language or similar programming languages. The program code may be executed entirely on a user's computer, partly executed on a user's computer, executed as an independent software package, partly executed on a user's computer and partly executed on a remote computer, or entirely executed on a remote computer or server. In the case of involving a remote computer, the remote computer may be connected to a user's computer through any kind of network, including a local area network (LAN) or a wide area network (WAN), or it may be connected to an external computer (for example, connected by using Internet provided by an Internet service provider).

The flowcharts and block diagrams in the accompanying drawings illustrate possible architecture, function, and operation implementations of a system, method, and computer program product according to various embodiments of the present disclosure. In this regard, each block in a flowchart or block diagram may represent a module, program segment, or part of code, which contains one or more executable instructions for realizing specified logic functions. It should also be noted that, in some alternative implementations, functions marked in a block may also occur in a different order than the order marked in the drawings. For example, two blocks shown in succession may actually be executed substantially in parallel, and they may sometimes be executed in the reverse order, depending on functions involved. It should also be noted that each block in a block diagram and/or flowchart, and the combination of blocks in a block diagram and/or flowchart, may be implemented by a dedicated hardware-based system that performs the specified functions or operations, or it may be implemented by a combination of dedicated hardware and computer instructions.

The units involved in the embodiments of the present disclosure may be implemented in software or hardware. The name of the unit does not constitute a limitation on the unit itself under certain circumstances.

The functions described herein above may be performed at least in part by one or more hardware logic components. For example, without limitation, exemplary types of hardware logic components that may be used include: Field Programmable Gate Array (FPGA), Application Specific Integrated Circuit (ASIC), Application Specific Standard Product (ASSP), System on Chip (SOC), Complex Programmable Logical device (CPLD) and so on.

In the context of the present disclosure, a machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an explanation to the technical principles applied. Those skilled in the art should understand that the scope of disclosure involved in this disclosure is not limited to technical solutions formed by specific combination of above technical features, and should also cover other technical solutions formed by arbitrarily combining above technical features or equivalent features thereof without departing from above disclosed concept. For example, those technical solutions formed by exchanging of the above features and technical features disclosed in the present disclosure (but not limited to) having similar functions with each other.

In addition, although various operations are depicted in a specific order, this should not be understood as requiring these operations to be performed in the specific order shown or performed in a sequential order. Under certain circumstances, multitasking and parallel processing may be advantageous. Likewise, although several specific implementation details are included in above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. Rather, the specific features and actions described above are merely exemplary forms for implementing the claims.

1. A multi-user multimedia control method, applied to a first client, the multimedia control method comprising:
acquiring a time alignment request, which is sent by a second client in response to a multimedia sharing joining operation, and sending time information to the second client, such that the second client aligns the time thereof with that of the first client based on the time information, wherein there is at least one second client, and the multimedia sharing is an interactive function among a plurality of clients;
in response to receiving at least two control instructions carrying instruction times within a preset time, determining a target control instruction based on each instruction time;
performing a corresponding control operation on a target multimedia corresponding to the target control instruction, and sending the target control instruction to the second client, such that the second client synchronously performs the same control operation on the target multimedia.

2. The multimedia control method according to claim 1, wherein determining a target control instruction based on each instruction time comprises:
comparing the instruction times of the at least two control instructions, and determining a control instruction with the latest instruction time as the target control instruction based on the comparison result.

3. The multimedia control method according to claim 1, wherein, after the time of the second client is aligned with that of the first client, the instruction times of the at least two control instructions are located on the same timeline.

4. The multimedia control method according to claim 1, wherein, after determining a target control instruction based on each instruction time, the multimedia control method further comprises:
in response to a sending end of the target control instruction being the first client, sending a rejection instruction to the second client among clients corresponding to the at least two control instructions.

5. The multimedia control method according to claim 1, wherein the preset time is a time period for the first client to determine the target control instruction.

6. The multimedia control method according to claim 1, wherein the control operation includes at least one of a play operation, a pause operation, a progress control operation and an interactive operation, and the multimedia includes a video, a media file composed of at least one of images or texts and supporting playback.

7. A multi-user multimedia control method, applied to a second client, the multimedia control method comprising:
sending a time alignment request to a first client in response to a multimedia sharing joining operation, and acquiring time information returned by the first client;
aligning the time of the second client with that of the first client based on the time information;
sending a control instruction carrying instruction time to the first client in response to a control triggering operation, such that the first client, in response to receiving at least two control instructions carrying instruction times within a preset time, determines a target control instruction based on each instruction time, and performs a corresponding control operation on a target multimedia corresponding to the target control instruction;
receiving the target control instruction and performing the same control operation as the first client on the target multimedia.

8. The multimedia control method according to claim 7, wherein the time alignment request includes a first time when the request is sent, and the time information includes a second time when the first client receives the time alignment request;
aligning the time of the second client with that of the first client based on the time information comprises:
determining a delay between the second client and the first client based on the first time, the second time, a third time when the time information is received, and a delay formula;
adding the delay to a real time of the second client to achieve time alignment with the first client.

9. The multimedia control method according to claim 8, further comprising:
in response to the delay being greater than or equal to a delay threshold, displaying an alignment failure notification.

10. The multimedia control method according to claim 7, wherein the step of aligning the time of the second client with that of the first client is executed a preset number of times every set time.

11. A multi-user multimedia control method, applied to a system including a first client and at least one second client, the multimedia control method comprising:
sending, by the second client, a time alignment request to the first client in response to a multimedia sharing joining operation;
acquiring, by the first client, the time alignment request and sending time information to the second client;
aligning, by the second client, the time of the second client with that of the first client based on the time information, and sending a control instruction carrying instruction time to the first client in response to a control trigger operation;
determining, by the first client in response to receiving at least two control instructions carrying instruction times within a preset time, a target control instruction based on each instruction time, and performing a corresponding control operation on a target multimedia corresponding to the target control instruction, sending the target control instruction to the second client;
receiving, by the second client, the target control instruction and performing the same control operation as the first client on the target multimedia.

12-14. (canceled)

15. An electronic device, comprising:
a processor;
a memory for storing instructions executable by the processor;
the processor being configured to read the executable instructions from the memory and execute the instructions to implement the multi-user multimedia control method of claim 1.

16. A non-transitory computer-readable storage medium having a computer program stored thereon, which is configured to execute the multi-user multimedia control method of claim 1.

17-18. (canceled)

19. An electronic device, comprising:
a processor;
a memory for storing instructions executable by the processor;
the processor being configured to read the executable instructions from the memory and execute the instructions to implement the multi-user multimedia control method of claim 7.

20. An electronic device, comprising:
a processor;
a memory for storing instructions executable by the processor;
the processor being configured to read the executable instructions from the memory and execute the instructions to implement the multi-user multimedia control method of claim 2.

21. An electronic device, comprising:
a processor;
a memory for storing instructions executable by the processor;
the processor being configured to read the executable instructions from the memory and execute the instructions to implement the multi-user multimedia control method of claim 3.

22. An electronic device, comprising:
a processor;
a memory for storing instructions executable by the processor;
the processor being configured to read the executable instructions from the memory and execute the instructions to implement the multi-user multimedia control method of claim 4.

23. A non-transitory computer-readable storage medium having a computer program stored thereon, which is configured to execute the multi-user multimedia control method of claim 7.

24. A non-transitory computer-readable storage medium having a computer program stored thereon, which is configured to execute the multi-user multimedia control method of claim 2.

25. A non-transitory computer-readable storage medium having a computer program stored thereon, which is configured to execute the multi-user multimedia control method of claim 3.
